(19) United States
(12) Patent Application Publication
(10) Pub. No.: US 2016/0370521 A1
(43) Pub. Date: Dec. 22, 2016

(54) BLUE LIGHT POLARIZATION FILM AND ITS MANUFACTURING METHOD, BLUE BACKLIGHT AND LIQUID CRYSTAL DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventor: Ang XIAO, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 14/771,141

(22) PCT Filed: Jan. 30, 2015
(86) PCT No.: PCT/CN2015/071954

§ 371 Date: Aug. 27, 2015

(30) Foreign Application Priority Data
Nov. 17, 2014 (CN) 201410652610.X

(51) Int. Cl. G02B 5/30; G02F 1/1335; C09K 11/06

(52) U.S. Cl. CPC G02B 5/305; C09K 11/06; G02F 1/133528; G02F 1/133514; G02F 1/133621; C09K 2211/186

(57) ABSTRACT

Disclosed are a blue light polarization film and its manufacturing method, as well as a blue backlight and a liquid crystal display device. The blue light polarization film is of a multi-layered film formed by depositing magnesium aluminum hydrotalcite and tri(8-hydroxyquinoline-5-sulfoacid) aluminum alternately. A maximum emission in a fluorescence spectrum of the blue light polarization film is 470 nm to 490 nm, fallen into a blue region. The blue light polarization film is of a fluorescence anisotropic value of 0.1 to 0.2, has a polarization property, and may be used as a liquid crystal display device.

### CROSS-REFERENCE TO RELATED APPLICATION

This application claims a priority to Chinese Patent Application No. 201410652610.X filed on Nov. 17, 2014, the disclosure of which is incorporated in its entirety by reference herein.

### TECHNICAL FIELD

The present disclosure relates to the field of organic electroluminescence technology, in particular to a blue light polarization film and its manufacturing method, as well as a blue backlight and a liquid crystal display device.

### BACKGROUND

During the developing process of an organic electroluminescence, since a blue light material is relative scarce, how to realize blue light emission has become a critical issue. If the blue light emission is realized, then it may further constitute tri-phosphor emission with green and red light emission, thereby obtain white light emission.

In a related art, a luminescent material needs to be added into an inorganic material or a polymer so as to achieve a certain uniform fluorescence intensity. However, such method may increase difficulties in synthesizing a luminescent material and controlling a uniformity of a luminescent film. In addition, such method may consume much more luminescent materials to achieve a same fluorescence intensity at cost.

### SUMMARY

An object of the present disclosure is to provide a blue light polarization film and its manufacturing method, as well as a blue backlight.

In an aspect, the present disclosure provides in embodiments a blue light polarization film, comprising a plurality of magnesium aluminum hydrotalcite layers and tri(8-hydroxyquinoline-5-sulfoacid) aluminum layers deposited alternately.

Alternatively, the multi-layered film comprises4 layers to 10 layers.

Alternatively, a thickness of each magnesium aluminum hydrotalcite layer is 10 nm to 20 nm; and a thickness of each tri(8-hydroxyquinoline-5-sulfoacid) aluminum layer is 10 nm to 20 nm.

Alternatively, a maximum value for a fluorescence emission spectrum is 470 nm to 490 nm.

Alternatively, the blue light polarization film is obtained by: repeating the step of immersing a base into a magnesium aluminum hydrotalcite solution at a concentration of 10 g/L to 20 g/L for 10 min to 15 min followed by taking out and blow-drying, and immersing the base into a tri(8-hydroxyquinoline-5-sulfoacid) aluminum solution at a concentration of 3 g/L to 10 g/L for 10 min to 15 min followed by taking out and blow-drying.

In another aspect, the present disclosure provides in embodiments a method for manufacturing a blue light polarization film, including:

repeating the step of immersing a base into a magnesium aluminum hydrotalcite solution at a concentration of 10 g/L to 20 g/L for 10 min to 15 min followed by taking out and blow-drying, and immersing the base into a tri(8-hydroxyquinoline-5-sulfoacid) aluminum solution at a concentration of 3 g/L to 10 g/L for 10 min to 15 min followed by taking out and blow-drying, so as to obtain a multi-layered film.

Alternatively, the two immersing steps are repeated twice to five times.

In yet another aspect, the present disclosure provides in embodiments a blue backlight, including any one of the above blue light polarization films.

In still yet another aspect, the present disclosure provides in embodiments a liquid crystal display device, including: an upper polarizer, a color filter substrate, a liquid crystal layer, an array substrate, a lower polarizer and a backlight, wherein the backlight is the above blue backlight.

According to embodiments of the present disclosure, a maximum value for a fluorescence emission spectrum of the blue light polarization film is 470 nm to 490 nm, fallen into a blue region. The blue light polarization film is of a fluorescence anisotropic value of 0.1 to 0.2, has a polarization property, and may be used as a liquid crystal display device. Therefore, the blue light polarization film not only has a luminous property, but also has a polarization property, thereby improves disadvantages of conventional liquid crystal display device, which requires both a polarizer at a backlight side and a luminous material in the backlight.

### DETAILED DESCRIPTION

The blue light polarization film is of a multi-layered film formed by depositing magnesium aluminum hydrotalcite and tri(8-hydroxyquinoline-5-sulfoacid) aluminum alternately. The multi-layered film formed by depositing alternately is uniform and compact. Because it may accurately control each single-layer film to be of a certain thickness, thereby control a certain thickness of the alternately-deposited multi-layered film. Further, it may control the luminescent intensity of such multi-layered film in an accurate manner by controlling the number of deposited layers. For the method of alternately depositing according to the present disclosure, the blue light material (formed by tri(8-hydroxyquinoline-5-sulfoacid) aluminum film) is of a low concentration, and the magnesium aluminum hydrotalcite may isolate two layers of the blue light film, thereby avoid the blue light material from flurescence quenching. Therefore, the more layers of the multi-layered film are, the more blue light material is deposited, and the higher of the blue light intensity are.

Alternatively, the multi-layered film comprises 4 layers to 10 layers; a thickness of each magnesium aluminum hydrotalcite layer is 10 nm to 20 nm; and a thickness of each tri(8-hydroxyquinoline-5-sulfoacid) aluminum layer is 10 nm to 20 nm.

Alternatively, a maximum value for a fluorescence emission spectrum of the blue light polarization film is 470 nm to 490 nm, fallen into a blue light region.

Alternatively, the blue light polarization film is obtained by: repeating the step of immersing a base into a magnesium aluminum hydrotalcite solution at a concentration of 10 g/L to 20 g/L for 10 min to 15 min followed by taking out and blow-drying, and immersing the base into a tri(8-hydroxyquinoline-5-sulfoacid) aluminum solution at a concentration of 3 g/L to 10 g/L for 10 min to 15 min followed by taking out and blow-drying.

In another aspect, the present disclosure further discloses in embodiments a blue backlight, including any one of the above blue light polarization films.

In still another aspect, the present disclosure provides in embodiments a liquid crystal display device, including an upper polarizer, a color filter substrate, a liquid crystal layer, an array substrate, a lower polarizer and a backlight, wherein the backlight is the above blue backlight.

### EXAMPLE 1

### Manufacturing a Blue Light Polarization Film

### 1.1 Manufacturing Magnesium Aluminum Hydrotalcite

The magnesium aluminum hydrotalcite, having a formula of Mg₂Al(OH)₆NO₃LDH ([Mg₂Al(OH)₆NO₃].xH₂O) was obtained by the following steps. Mg(NO₃)₂.6H₂O and Al(NO₃)₃.6H₂O were dissolved in 100 mL deionized aqueous solution at a molar ratio of 2:1, Mg(NO₃)₂.6H₂O being at a concentration of 0.02 mol/L. After transferred to a three-necked bottle, the resultant solution was stirred in a protection of nitrogen gas and titrated to be at a pH value of 8.0 with 0.5 mol/L NaOH. The mixed solution was then transferred into a reaction kettle and subjected to a reaction for 48 hours in an oven at 80° C. The target product of Mg₂Al(OH)₆NO₃LDH was obtained after centrifuging, washing and drying the reaction product.

### 1.2 Manufacturing a Magnesium Aluminum Hydrotalcite Solution

1 g Mg₂Al(OH)₆NO₃LDH was added into 100 mL of formamide followed by 16 hours stirring, so as to obtain a LDH-formamide layer-stripping solution, carrying positive charges.

### 1.3 Manufacturing tri(8-hydroxyquinoline-5-sulfoacid) Aluminum

1.35 g 8-hydroxyquinoline-5-sulfoacid was dissolved in 150 mL water. After transferring the resultant solution into a three-necked bottle, 0.24 g NaOH was add in the resultant solution while stirring sufficiently, then 0.27 g aluminium chloride was added, and then the resultant solution was adjusted to be at a pH value of 8.0 with 1 mol/L NaOH solution, stirring the obtained solution and performing the reaction at a room temperature for 12 hours. A greenyellow solid was obtained after drying reacted solution in a water bath at 90° C. and washing with ethanol. The target product of tri(8-hydroxyquinoline-5-sulfoacid) aluminum was obtained after dissolving the greenyellow solid in 100 mL of methanol and then extracting by ether.

TABLE 1
Element analysis of tri(8-hydroxyquinoline-5-sulfoacid) aluminum

| | C % | N % | H % |
|---|---|---|---|
| measured value | 33.78 | 4.35 | 3.12 |
| theoretical value | 33.78 | 4.38 | 3.81 |

### 1.4 manufacturing a tri(8-hydroxyquinoline-5-sulfoacid) Aluminum Solution

The tri(8-hydroxyquinoline-5-sulfoacid) aluminum aqueous solution, bearing negative charges was prepared with water to be of a concentration of 3 g/L.

### 1.5 Manufacturing the Blue Light Polarization Film

An ITO substrate was immersed into the magnesium aluminum hydrotalcite solution for 10 min followed by blow-drying, and then immersed into the tri(8-hydroxyquinoline-5-sulfoacid) aluminum solution for 10 min followed by blow-drying, thereby completed one step. The above step was repeated for three times, so as to obtain the blue light polarization film. In the blue light polarization film, the magnesium aluminum hydrotalcite and the tri(8-hydroxyquinoline-5-sulfoacid) aluminum were combined with each other through an electrostatic interaction. Each of the magnesium aluminum hydrotalcite and the tri(8-hydroxyquinoline-5-sulfoacid) aluminum was of a thickness of 10 nm determined by a scanning electron microscope.

### 1.6 Luminescent Spectrum Test

Exciting light wavelength was 360 nm. Results of the luminescent spectrum test were shown in Table 2.

TABLE 2

| | commonly-used blue | tri(8- | |
|---|---|---|---|
| | light material tri(8- | hydroxyquinoline- | |
| | hydroxyquinoline) | 5-sulfoacid) | blue light |
| | aluminum film | aluminum | polarization |
| | (control 1) | (control 2) | film |
| maximum | 532 nm | 495 nm | 470 nm |
| emission | | | |
| value of the | | | |
| luminescent | | | |
| spectrum | | | |
| fluorescence | 0.02 | 0.02 | 0.15 |
| anisotropic | | | |
| value | | | |

It can be seen from Table 2 that a maximum value for a fluorescence emission spectrum of the blue light polarization film is 476 nm, fallen in a blue light region.

### EXAMPLE 2

### Manufacturing a Blue Light Polarization Film

### 2.1 Manufacturing Magnesium Aluminum Hydrotalcite

The magnesium aluminum hydrotalcite, having a formula of Mg₂Al(OH)₆NO₃LDH ([Mg₂Al(OH)₆NO₃].xH₂O) was obtained by the following steps. Mg(NO₃)₂.6H₂O and Al(NO₃)₃.6H₂O were dissolved in 100 mL deionized aqueous solution at a molar ratio of 2:1, Mg(NO₃)₂.6H₂O being at a concentration of 0.12 mol/L. After transferred to a three-necked bottle, the resultant solution was stirred in a protection of nitrogen gas and titrated to be at a pH value of 10.5 with 0.5 mol/L NaOH. The mixed solution was then transferred into a reaction kettle and subjected to a reaction for 10 hours in an oven at 160° C. . The target product of Mg₂Al(OH)₆NO₃LDH was obtained after centrifuging, washing and drying the reaction product.

### 2.2 Manufacturing a Magnesium Aluminum Hydrotalcite Solution

2 g Mg₂Al(OH)₆NO₃LDH was added into 100 mL of formamide followed by 16 hours stirring, so as to obtain a LDH-formamide layer-stripping solution, carrying positive charges.

### 2.3 Manufacturing tri(8-hydroxyquinoline-5-sulfoacid) Aluminum

1.35 g 8-hydroxyquinoline-5-sulfoacid was dissolved in 150 mL water. After transferring the resultant solution into a three-necked bottle, 0.24 g NaOH was added into the resultant solution while stirring sufficiently, then 0.27 g aluminium chloride was added, and the resultant solution was adjusted to be at a pH value of 8.0 with 1 mol/L NaOH solution, stirring the obtained solution and performing the reaction at a room temperature for 12 hours. A greenyellow solid was obtained after drying reacted solution in a water bath at 90° C. and washing with ethanol. The target product of tri(8-hydroxyquinoline-5-sulfoacid) aluminum was obtained after dissolving the greenyellow solid in 100 mL of methanol and then extracting by ether.

TABLE 3
Element analysis of tri(8-hydroxyquinoline-5-sulfoacid) aluminum

| | C % | N % | H % |
|---|---|---|---|
| measured value | 33.78 | 4.35 | 3.12 |
| theoretical value | 33.78 | 4.38 | 3.81 |

### 2.4 Manufacturing a tri(8-hydroxyquinoline-5-sulfoacid) Aluminum Solution

The tri(8-hydroxyquinoline-5-sulfoacid) aluminum aqueous solution, bearing negative charges was prepared with water to be of a concentration of 10 g/L.

### 2.5 Manufacturing the Blue Light Polarization Film

An ITO substrate was immersed into the magnesium aluminum hydrotalcite solution for 15 min followed by blow-drying, and then immersed into the tri(8-hydroxyquinoline-5-sulfoacid) aluminum solution for 15 min followed by blow-drying, thereby completed one step. The above step was repeated for three times, so as to obtain the blue light polarization film. In the blue light polarization film, the magnesium aluminum hydrotalcite and the tri(8-hydroxyquinoline-5-sulfoacid) aluminum were combined with each other through an electrostatic interaction. Each of the magnesium aluminum hydrotalcite and the tri(8-hydroxyquinoline-5-sulfoacid) aluminum was of a thickness of 20 nm determined by a scanning electron microscope.

### 1.6. luminescent Spectrum Test

Exciting light wavelength was 360 nm. Results of the luminescent spectrum test were shown in Table 4.

TABLE 4

| | | tri(8- | |
|---|---|---|---|
| | tri(8- | hydroxyquinoline- | blue light |
| | hydroxyquinoline) | 5-sulfoacid) | polarization |
| | aluminum film | aluminum | film |
| maximum | 532 nm | 495 nm | 480 nm |
| emission | | | |
| value of the | | | |
| luminescent | | | |
| spectrum | | | |
| fluorescence | 0.02 | 0.02 | 0.15 |
| anisotropic | | | |
| value | | | |

It can be seen from Table 4 that a maximum value for a fluorescence emission spectrum of the blue light polarization film is 480 nm, fallen in a blue light region.

The above are merely the preferred embodiments of the present disclosure. It should be appreciated that, a person skilled in the art may make further improvements and modifications without departing from the principle of the present disclosure, and these improvements and modifications shall also fall within the scope of the present disclosure.

What is claimed is:

1. A blue light polarization film, comprising a plurality of magnesium aluminum hydrotalcite layers and tri(8-hydroxyquinoline-5-sulfoacid) aluminum layers deposited alternately.

2. The blue light polarization film according to claim 1, wherein the blue light polarization film comprises 4 layers to 10 layers.

3. The blue light polarization film according to claim 1 or 2, wherein a thickness of each magnesium aluminum hydrotalcite layer is 10 nm to 20 nm; and a thickness of each tri(8-hydroxyquinoline-5-sulfoacid) aluminum layer is 10 nm to 20 nm.

4. The blue light polarization film according to claim 1, wherein a maximum value for a fluorescence emission spectrum of the blue light polarization film is 470 nm to 490 nm.

5. The blue light polarization film according to claim 1, wherein the blue light polarization film is obtained by:
repeating steps of immersing a base into a magnesium aluminum hydrotalcite solution at a concentration of 10 g/L to 20 g/L for 10 min to 15 min followed by taking out and blow-drying, and immersing the base into a tri(8-hydroxyquinoline-5-sulfoacid) aluminum solution at a concentration of 3 g/L to 10 g/L for 10 min to 15 min followed by taking out and blow-drying.

6. A method for manufacturing a blue light polarization film, comprising:
repeating steps of immersing a base into a magnesium aluminum hydrotalcite solution at a concentration of 10 g/L to 20 g/L for 10 min to 15 min followed by taking out and blow-drying, immersing the base into a tri(8-hydroxyquinoline-5-sulfoacid) aluminum solution at a concentration of 3 g/L to 10 g/L for 10 min to 15 min followed by taking out and blow-drying.

7. The method according to claim 6, wherein the steps are repeated twice to five times.

8. The method according to claim 6, wherein magnesium aluminum hydrotalcite is obtained by the following steps:
dissolving Mg(NO₃)₂.6H₂O and Al(NO₃)₃.6H₂O in 100 mL deionized aqueous solution at a molar ratio of 2:1, Mg(NO₃)₂.6H₂O being at a concentration of 0.12 mol/L;
transferring the resultant solution to a three-necked bottle, stirring the resultant solution in the presence of nitrogen gas and titrating the resultant solution to be at a pH value of 8.0 to 10.5 with 0.5 mol/L NaOH;
transferring the obtained solution to a reaction kettle and subjecting the obtained solution to reaction for 10 hours to 48 hours in an oven at 80° C. to 160° C.; and
centrifuging, washing and drying a reaction product, so as to obtain a target product of Mg₂Al(OH)₆NO₃LDH.

9. The method according to claim 6, wherein tri(8-hydroxyquinoline-5-sulfoacid) aluminum is obtained by the following steps:
dissolving 1.35 g 8-hydroxyquinoline-5-sulfoacid in 150 mL water followed by transferring the resultant solution to a three-necked bottle;
adding 0.24 g NaOH into the resultant solution, stirring the resultant solution sufficiently, adding 0.27 g aluminium chloride, and then adjusting the obtained solution to be at a pH value of 8.0 with 1 mol/L NaOH solution;
stirring the obtained solution and performing the reaction at a room temperature for 12 hours;
drying the reacted solution in a water bath at 90° C.;
washing with ethanol so as to obtain a greenyellow solid; and
dissolving the greenyellow solid into 100 mL methanol, and adding ether so as to extract a target product of the tri(8-hydroxyquinoline-5-sulfoacid) aluminum.

10. The method according to claim 6, wherein the magnesium aluminum hydrotalcite solution is a magnesium aluminum hydrotalcite-formamide solution.

11. The method according to claim 10, wherein the tri(8-hydroxyquinoline-5-sulfoacid) aluminum solution is a tri(8-hydroxyquinoline-5-sulfoacid) aluminum aqueous solution.

12. A blue backlight, comprising the blue light polarization film according to claim 1.

13. A liquid crystal display device, comprising: an upper polarizer, a color filter substrate, a liquid crystal layer, an array substrate, a lower polarizer and a backlight, wherein the backlight is the blue backlight according to claim 8.

14. The blue light polarization film according to claim 2, wherein a thickness of each magnesium aluminum hydrotalcite layer is 10 nm to 20 nm; and a thickness of each tri(8-hydroxyquinoline-5-sulfoacid) aluminum layer is 10 nm to 20 nm.

15. The blue light polarization film according to claim 2, wherein a maximum value for a fluorescence emission spectrum of the blue light polarization film is 470 nm to 490 nm.

16. The blue light polarization film according to claim 3, wherein a maximum value for a fluorescence emission spectrum of the blue light polarization film is 470 nm to 490 nm.

17. The blue light polarization film according to claim 14, wherein a maximum value for a fluorescence emission spectrum of the blue light polarization film is 470 nm to 490 nm.

18. The method according to claim 7, wherein magnesium aluminum hydrotalcite is obtained by the following steps:
dissolving Mg(NO₃)₂.6H₂O and Al(NO₃)₃.6H₂O in 100 mL deionized aqueous solution at a molar ratio of 2:1, Mg(NO₃)₂.6H₂O being at a concentration of 0.12 mol/L;
transferring the resultant solution to a three-necked bottle, stirring the resultant solution in the presence of nitrogen gas and titrating the resultant solution to be at a pH value of 8.0 to 10.5 with 0.5 mol/L NaOH;
transferring the obtained solution to a reaction kettle and subjecting the obtained solution to reaction for 10 hours to 48 hours in an oven at 80° C. to 160° C.; and
centrifuging, washing and drying a reaction product, so as to obtain a target product of Mg₂Al(OH)₆NO₃LDH.

19. The method according to claim 7, wherein tri(8-hydroxyquinoline-5-sulfoacid) aluminum is obtained by the following steps:
dissolving 1.35 g 8-hydroxyquinoline-5-sulfoacid in 150 mL water followed by transferring the resultant solution to a three-necked bottle;
adding 0.24 g NaOH into the resultant solution, stirring the resultant solution sufficiently, adding 0.27 g aluminium chloride, and then adjusting the obtained solution to be at a pH value of 8.0 with 1 mol/L NaOH solution;
stirring the obtained solution and performing the reaction at a room temperature for 12 hours;
drying the reacted solution in a water bath at 90° C.;
washing with ethanol so as to obtain a greenyellow solid; and
dissolving the greenyellow solid into 100 mL methanol, and adding ether so as to extract a target product of the tri(8-hydroxyquinoline-5-sulfoacid) aluminum.
